(19) United States
(12) Patent Application Publication
(10) Pub. No.: US 2025/0319531 A1
(43) Pub. Date: Oct. 16, 2025

(54) MILLING TOOL AND METHOD FOR DESIGNING A MILLING TOOL OF THIS TYPE

(71) Applicant: MAPAL FABRIK FUR PRAZISIONSWERKZEUGE DR. KRESS KG, Aalen (DE)

(72) Inventors: Matthias SCHNEIDER, Bopfingen (DE); Florian HECKMANN, Aalen (DE); Mathias HORNUNG, Aalen (DE)

(21) Appl. No.: 18/867,362

(22) PCT Filed: Jun. 26, 2023
(86) PCT No.: PCT/EP2023/067353

§ 371 Date: Nov. 19, 2024

(30) Foreign Application Priority Data
Jun. 30, 2022 (DE) 10 2022 116 414.4

(51) Int. Cl. B23C 5/06

(52) U.S. Cl. CPC B23C 5/06; B23C 2210/282; B23C 2210/285; B23C 2210/287; B23C 2220/605

(57) ABSTRACT

The invention relates to a milling tool having a plurality of first blades and at least one second blade, which are arranged on the milling tool in a staggered manner in the circumferential direction of the milling tool, wherein
the plurality of first blades are arranged in the axial direction of the milling too at a nominal position, wherein
the plurality of first blades comprises a compensation group having at least one compensation blade and at least one non-compensation blade, wherein
the at least one non-compensation blade is assigned a nominal cutting circle, wherein
the at least one compensation blade is assigned a compensation cutting circle, wherein
the nominal cutting circle and the compensation cutting circle are different, wherein
the at least one second blade is offset forward in the axial direction of the milling tool by a forward offset with respect to the nominal position in the direction of a machining front end, wherein
the at least one second blade is assigned a surface machining cutting circle, wherein
the surface machining cutting circle is smaller than the nominal cutting circle and than the compensation cutting circle, wherein
the at least one second blade leads the plurality of first blades in the circumferential direction.

### CROSS-REFERENCE TO RELATED APPLICATIONS

This application is a U.S. National Phase application under 35 U.S.C. 371 of International Application No. PCT/EP2023/067353, filed on Jun. 26, 2023, which claims the benefit of German Patent Application No. 10 2022 116 414.4, filed on Jun. 30, 2022. The entire disclosures of the above patent applications are incorporated herein by reference.

### FIELD

The invention relates to a milling tool and a method for designing such a milling tool.

### BACKGROUND

This section provides background information related to the present disclosure which is not necessarily prior art.

When milling, the challenge—in particular in contrast to drilling or reaming—is that the blades of a milling tool do not permanently engage with a machined workpiece, but rather cyclically plunge into and out of the workpiece. For example, when using a wide finishing cutting edge as one blade of the milling tool, the wide finishing cutting edge engages less with the machined workpiece than the other blades, resulting in a smaller machining volume than an average machining volume per blade associated with the milling tool. Therefore, if the feed rate of the milling tool is constant, a blade that lags behind the wide finishing cutting edge has to remove more material from the workpiece. In particular, the blade has a higher machining volume than the average machining volume associated with the milling tool. This places an excessive load on the blade that lags behind the wide finishing cutting edge, resulting in increased wear on that blade. This in turn leads to uneven wear and to different service lives of the different blades.

### SUMMARY

This section provides a general summary of the disclosure, and is not a comprehensive disclosure of its full scope or all of its features.

The invention is based on the task of creating a milling tool and a method for designing such a milling tool, wherein the disadvantages mentioned at least partially do not occur.

The task is solved by providing the present technical teaching, in particular the teaching of the independent claims as well as the embodiments disclosed in the dependent claims and the description.

The task is solved in particular by creating a milling tool with a plurality of first blades and at least one second blade, wherein the plurality of first blades and the at least one second blade are arranged on the milling tool in a staggered manner in the circumferential direction of the milling tool. The first blades are arranged in the axial direction of the milling tool at a nominal position. Furthermore, the plurality of first blades comprises a compensation group having at least one compensation blade and at least one non-compensation blade. A nominal cutting circle is assigned to the at least one non-compensation blade. A compensation cutting circle is assigned to the at least one compensation blade. Furthermore, the nominal cutting circle and the compensation cutting circle differ from one another. The at least one second blade is offset forward in the axial direction of the milling tool by a forward offset with respect to the nominal position in the direction of a machining front end. In addition, the at least one second blade is assigned a surface machining cutting circle, where the surface machining cutting circle is smaller than the nominal cutting circle and than the compensation cutting circle. The at least one second blade leads the plurality of first blades in the circumferential direction. In this way, the different machining volumes per blade due to the at least one second blade can be advantageously aligned with each other. The machining volume per blade is a measure of the machining performance provided by the respective blade. In particular, a lateral, i.e. radial, alignment of the compensation blades can be adapted in such a way that the machining volumes per blade are at least substantially equal, preferably equal, for each blade. This also results in a more even distribution of force at the blades, which therefore also comprise a more even and, in particular, longer tool life.

In particular, a machining volume that is not provided by the second blade due to the radial back offset resulting from the surface machining cutting circle is distributed to the blades of the compensation group. This increases the machining volume of the at least one compensation blade and the at least one non-compensation blade compared to a first blade that is not assigned to the compensation group. In particular, given a fixed machining volume not provided by the second blade, it is possible to reduce the additional machining volume per blade of the compensation group, the greater the number of blades of the compensation group is.

Furthermore, the machining volume provided by the second blade depends on the radial back offset of the second blade, wherein the machining volume of the second blade is reduced as the back offset increases. In particular, the machining volume of the second blade is zero as soon as the radial back offset is equal to a threshold back offset. This means that the machining volume not provided by the second blade is constant—in particular, it corresponds to a maximum machining volume—for a radial back offset that is greater than or equal to the threshold back offset. Therefore, it is possible to increase the machining volume not provided by the second blade for a fixed additional machining volume per blade of the compensation group, in particular until the maximum machining volume is reached, the greater the number of blades of the compensation group is.

In this context, milling is understood to mean a machining process with a rotating tool. The blades of the milling tool generate the cutting movement by rotating around a tool centre axis of the milling tool as the axis of rotation. At the same time, a feed movement is effected between the milling tool and a machined workpiece. The feed movement can be carried out on the milling tool and/or on the workpiece.

The axial direction extends in the direction of the tool centre line, i.e. the intended axis of rotation of the milling tool. The circumferential direction extends concentrically around the tool centre axis. A radial direction is perpendicular to the tool centre axis.

The blades comprise, in particular, cutting edges of the milling tool. The cutting edges can be configured directly on a base body of the milling tool or on cutting inserts, in particular cutter plates or indexable inserts, which are attached to the base body, for example screwed or soldered to the base body. In particular, the cutting edges are main cutting edges of an associated cutting edge geometry.

The blades are arranged on the base body of the milling tool in such a way that they are offset from one another in the circumferential direction, i.e. in pairs with a finite angular distance from one another, on the base body.

A blade that is leading in relation to another blade is understood to be a blade that—when viewed in the direction of rotation of the milling tool—is leading in relation to the blade under consideration, i.e. it is arranged in front of the blade under consideration when viewed in the direction of rotation of the milling tool and preferably comes into contact with the material of the workpiece before the blade under consideration when machining a workpiece. Furthermore, a blade that immediately leads another blade is understood to be a blade that—viewed in the direction of rotation of the milling tool—immediately leads the blade under consideration, i.e. is arranged in front of the blade under consideration when viewed in the direction of rotation of the milling tool and, preferably when machining a workpiece, comes into engagement with the material of the workpiece immediately in front of the blade under consideration.

A cutting circle is, in particular, an imaginary circle defined by the path described by a point on a cutting edge of a blade, which comprises the greatest distance from the centre axis of the tool along the cutting edge geometry, when the milling tool rotates around the centre axis of the tool.

The fact that a blade is assigned a cutting circle means, in particular, that the blade on the milling tool has the cutting circle, or, to put it another way, that the blade, in particular its cutting edge, is arranged on the milling tool with the corresponding cutting circle.

The nominal cutting circle is thus, in particular, a predetermined cutting circle for the milling tool, which determines a nominal machining diameter of the milling tool. In addition, the compensation cutting circle is determined and/or calculated based on the nominal cutting circle.

In particular, the at least one second blade is radially offset inwards with respect to the plurality of first blades, that is to say set back in the direction of the tool centre axis, since the surface machining cutting circle is smaller than the nominal cutting circle and the compensation cutting circle.

The nominal position is, in particular, a predetermined position for the milling tool along the axial direction at which the first blades, in particular the cutting edges of the first blades, are to be arranged.

The fact that the at least one second blade is offset forward in the axial direction of the milling tool by a forward offset with respect to the nominal position in the direction of a machining front end means that the at least one second blade projects in the axial direction in the direction of a workpiece to be machined with respect to a blade arranged in the nominal position.

In particular, the plurality of first blades and the at least one second blade differ in an arrangement of the blades in both the axial direction of the milling tool and the radial direction of the milling tool.

In particular, the material removal in the radial direction of the milling tool on a workpiece by means of one of the first blades is greater than the material removal in the radial direction of the milling tool on the workpiece by means of the at least one second blade. In particular, the removal of material in the axial direction of the milling tool on a workpiece by means of the at least one second blade is greater than the removal of material in the axial direction of the milling tool on the workpiece by means of one of the first blades.

In particular, the compensation cutting circle is smaller than the nominal cutting circle.

In particular, the nominal cutting circle is assigned to at least one first blade of the plurality of first blades that is not assigned to the compensation group.

In particular, at least one first blade arranged on the nominal cutting circle immediately leads in front of the at least one second blade.

In a further configuration, a second blade of the at least one second blade and a compensation blade of the at least one compensation blade are directly adjacent to one another in the circumferential direction. Furthermore, the one second blade immediately leads in front of the at least one compensation blade in the circumferential direction.

In particular, a machining direction of the milling tool is orthogonal to the axial direction of the milling tool.

The milling tool is displaced perpendicular to the tool centre axis, in particular in the machining direction, during milling. A specific feed per revolution of the milling tool is set, which is obtained as the quotient of the—linear—feed speed divided by the rotational speed of the milling tool.

In particular, the at least one second blade is configured as a wide finishing cutting edge.

According to a further development of the invention, it is provided that the compensation group comprises at least two compensation blades, wherein different compensation cutting circles are associated with the at least two compensation blades. In addition, the at least two compensation blades are directly adjacent to one another. Advantageously, it is thus possible to distribute the machining volume not produced by the at least one second blade among a plurality of first blades and thus to reduce the additional loads on the first blades associated with the compensation group.

In particular, this method ensures that the cutting performance and the machining volume are distributed evenly among the blades, so that their load, cutting performance, wear and tool life are homogenised in a favourable way.

In a configuration, a first compensation cutting circle is assigned to a first compensation blade and a second compensation cutting circle is assigned to a second compensation blade. The first compensation blade immediately follows the at least one second blade in the circumferential direction. Furthermore, the second compensation blade and the non-compensation blade are directly adjacent to one another. In particular, the first compensation cutting circle is smaller than the second compensation cutting circle and the second compensation cutting circle is smaller than the nominal cutting circle.

According to a further development of the invention, it is provided that the at least one non-compensation blade immediately follows the at least one compensation blade.

In a configuration, the non-compensation blade immediately follows the first compensation blade in the circumferential direction. Alternatively, the non-compensation blade immediately follows the second compensation blade in the circumferential direction. In particular, the non-compensation blade immediately follows the compensation blade comprising the largest compensation cutting circle in the circumferential direction.

According to a further development of the invention, it is provided that the plurality of first blades is configured for pre-machining the workpiece, in particular as roughing blades. Preferably, the at least one second blade is additionally configured for finish machining the workpiece, in particular as finishing blades.

In a particularly advantageous configuration, roughing and finishing operations can be carried out with the same milling tool, since the surface quality is increased. This in turn results in time and cost savings due to fewer tool changes and set-up work.

Due to the arrangement of the plurality of first blades and the at least one second blade, the milling tool is adapted to primarily machine a first workpiece surface orthogonal to the machining direction by means of the plurality of first blades and to primarily machine a second workpiece surface orthogonal to the axial direction by means of the at least one second blade. In particular, a workpiece is face-milled by means of the milling tool, and the in particular flat surface of the workpiece is machined and/or finished by means of the at least one second blade during the face milling. Alternatively or additionally, in particular by means of the at least one second blade, a bottom surface of a groove produced in the workpiece by means of the milling tool is machined and/or finished during the introduction of the groove, which is in particular primarily effected by means of the plurality of first blades.

According to a further development of the invention, it is provided that a first compensation blade of the at least one compensation blade is offset radially inwards by a first back offset relative to the nominal cutting circle and is arranged on a first compensation cutting circle.

According to a further development of the invention, it is provided that a second compensation blade of the at least two compensation blades is offset radially inward by a second back offset relative to the nominal cutting circle and is arranged on a second compensation cutting circle. The first back offset of the first compensation cutting circle relative to the nominal cutting circle is greater than the second back offset of the second compensation cutting circle relative to the nominal cutting circle.

According to a further development of the invention, it is provided that the first blades each include a splitting angle in pairs, wherein the splitting angles comprise a relative size difference of at most 15% among themselves.

The splitting angle αᵢ enclosed by two first blades in pairs is understood to be an angle that two first blades that are directly adjacent in the circumferential direction enclose with one another.

In a configuration, a nominal splitting angle α is predetermined, wherein all splitting angles αᵢ have a minimum value of 0.925*α and a maximum value of 1.075*α. The splitting angles αᵢ thus comprise a relative size difference of at most 15% with respect to the target splitting angle α. Alternatively, all splitting angles αᵢ comprise at most the value 1.15*min (αᵢ). The splitting angles αᵢ thus comprise a relative size difference of at most 15% with respect to a minimum splitting angle. Alternatively, all splitting angles αᵢ comprise at least 0.85*max (αᵢ). This means that the splitting angles αᵢ comprise a relative size difference of at most 15% in relation to a maximum splitting angle.

The task is also solved by providing a method for designing, preferably for manufacturing, a milling tool according to the invention or a milling tool according to one of the previously described embodiments, wherein an angular position for each of the plurality of first blades and the at least one second blade in the circumferential direction on the milling tool are determined. In addition, the nominal cutting circle of the at least one non-compensation blade is determined. A first compensation blade of the at least one compensation blade is radially set back relative to the nominal cutting circle by a first back offset. Preferably, the first back offset for the first compensation blade of the at least one compensation blade is selected as a function of at least one parameter, which is selected from a predetermined additional load of the compensation blades and a tooth feed per revolution for the milling tool. In connection with the method, there are in particular the advantages that have already been explained in connection with the milling tool.

In particular, a nominal position of the first blades, in particular of the cutting edges of the first blades, is further defined along the axial direction of the milling tool. In addition, a forward offset of the at least one second blade in the axial direction of the milling tool with respect to the nominal position in the direction of a machining front end is further defined.

In particular, the at least one compensation blade and the at least one non-compensation blade are also determined and/or defined.

In particular, a first compensation cutting circle is determined by means of the nominal cutting circle and the first back offset.

In particular, a surface machining cutting circle is defined for the at least one second blade in such a way that the surface machining cutting circle is smaller than the first compensation cutting circle and the nominal cutting circle.

In particular, the positions of the first blades and of the at least one second blade in the circumferential direction are defined in such a way that the at least one second blade leads the first blades, in particular the at least one compensation blade.

In particular, a value of at most 20%, in particular at most 25%, in particular at most 33%, in particular at most 33.33%, in particular at most 50%, is selected for the predetermined additional load q of the compensation blades.

In particular, a value of at least 0.01 mm to at most 0.5 mm, in particular 0.1 mm, in particular 0.111 mm, in particular 0.125 mm, in particular 0.139 mm, in particular 0.15 mm, in particular 0.153 mm, in particular 0.167 mm, in particular 0.181 mm, in particular 0.194 mm, in particular 0.200 mm, in particular 0.222 mm, in particular 0.236 mm, in particular 0.25 mm, is selected for the tooth feed per revolution f_{z} for the milling tool.

According to a further development of the invention, it is provided that a second compensation blade of the at least two compensation blades is set back radially relative to the nominal cutting circle by a second back offset, wherein the first back offset is greater than the second back offset. Furthermore, the second back offset for the second compensation blade is preferably selected as a function of at least one parameter, which is selected from the predetermined additional load of the compensation blades and a tooth feed per revolution for the milling tool.

According to a further development of the invention, it is provided that the tooth feed per revolution for the milling tool and the predetermined additional load of the compensation blades are determined first. A machining compensation based on the tooth feed and the predetermined additional load is then determined. A number of compensation blades is determined based on the machining compensation. After that, a back offset is determined for each blade of the number of compensation blades. The compensation blades are then offset radially inwards by the assigned back offset in relation to the nominal cutting circle.

In particular, the machining compensation K_{zer} is calculated using the equation

$${K}_{zer} = {f}_{z} * q \qquad ( 1 )$$

from the additional load q of the compensation blades and the tooth feed per revolution f_{z}.

In particular, the number of compensation blades is calculated using the equation

$${n}_{k} = ⌊ \frac{{f}_{z}}{max \{ {K}_{zer} , {K}_{min} \}} + 0.5 ⌋ - 1 \qquad ( 2 )$$

from the tooth feed per revolution f_{z}, the machining compensation K_{zer} and a manufacturing minimum compensation Kₘᵢₙ. In particular, the number of first blades is determined using the minuend in equation (2). In particular, the subtrahend is set to 1 because the milling tool, in particular the compensation group, comprises at least one non-compensation blade.

In particular, a value of at most 0.04 mm, in particular at most 0.05 mm, in particular at most 0.06 mm, in particular at most 0.07 mm, in particular at most 0.08 mm, in particular at most 0.09 mm, in particular at most 0.1 mm, is selected for the manufacturing-related minimum compensation Kₘᵢₙ. Preferably, the manufacturing minimum compensation Kₘᵢₙ is calculated using the equation

$${K}_{min} = 2 * ( {T}_{W Z} + {T}_{S} ) \qquad ( 3 )$$

from a manufacturing tolerance of the tool T_{WZ} and a manufacturing tolerance of the blades T_{S}.

In particular, the respective back offset rᵢ for i=1 to nₖ is calculated using the equation

$${r}_{i} = {f}_{z} - i * max \{ {K}_{zer} , {K}_{min} \} \qquad ( 4 )$$

from the tooth feed per revolution f_{z}, the machining compensation K_{zer} and the manufacturing minimum compensation Kₘᵢₙ.

In particular, Table 1 summarises the predetermined and/or calculated values from equations (1) to (4) for various configurations, wherein all values in columns 3 to 9 are given in millimeters.

TABLE 1
Overview of a plurality of different configurations of the milling
tool according to the invention with calculated back offsets rᵢ.

| Milling tool Nr. | q | f_{z} | K_{zer} | Kₘᵢₙ | nₖ | r₁ | r₂ | r₃ |
|---|---|---|---|---|---|---|---|---|
| 1 | 25% | 0.2 | 0.05 | 0.04 | 3 | 0.15 | 0.1 | 0.05 |
| 2 | 33.33% | 0.15 | 0.05 | 0.04 | 2 | 0.1 | 0.05 | — |
| 3 | 33.33% | 0.2 | 0.06666 | 0.1 | 1 | 0.1 | — | — |
| 4 | 50% | 0.3 | 0.15 | 0.1 | 1 | 0.15 | — | — |
| 5 | 33% | 0.236 | 0.07788 | 0.1 | 1 | 0.136 | — | — |
| 6 | 33% | 0.222 | 0.07326 | 0.1 | 1 | 0.122 | — | — |
| 7 | 33% | 0.2 | 0.066 | 0.1 | 1 | 0.1 | — | — |
| 8 | 33% | 0.194 | 0.06402 | 0.1 | 1 | 0.094 | — | — |
| 9 | 33% | 0.181 | 0.05973 | 0.1 | 1 | 0.081 | — | — |
| 10 | 33% | 0.167 | 0.05511 | 0.1 | 1 | 0.067 | — | — |
| 11 | 33% | 0.153 | 0.05049 | 0.1 | 1 | 0.053 | — | — |

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The invention is explained in more detail below on the basis of the drawings. The drawings show:

FIG. 1 a schematic representation of a first embodiment of a milling tool,

FIG. 2 a schematic representation of a second embodiment of the milling tool,

FIG. 3 a schematic representation of a third embodiment of the milling tool, and

FIG. 4 a flow chart of an embodiment of a method for designing the milling tool.

### DETAILED DESCRIPTION

Example embodiments will now be described more fully with reference to the accompanying drawings.

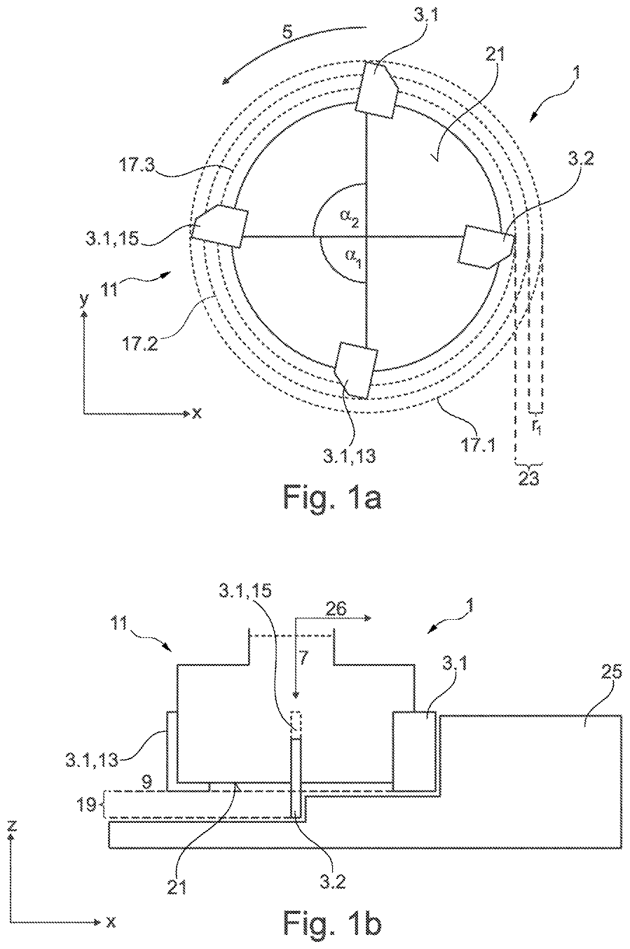

FIG. 1 shows a schematic representation of a first embodiment of a milling tool 1. The milling tool 1 comprises a plurality of first blades 3.1, in particular three first blades 3.1, and at least one second blade 3.2, in particular exactly one second blade 3.2, configured in particular as a wide finishing cutting edge. The blades 3 are arranged on the milling tool 1 in a staggered manner in the circumferential direction 5 of the milling tool 1—the arrow at 5 indicates the intended rotational direction of the milling tool 1. The plurality of first blades 3.1 are arranged in the axial direction 7 of the milling tool 1 at a nominal position 9. The plurality of first blades 3.1 includes a compensation group 11 having at least one compensation blade 13, in particular exactly one compensation blade 13, and at least one non-compensation blade 15. A nominal cutting circle 17.1 is assigned to the at least one non-compensation blade 15. A compensation cutting circle 17.2 is assigned to the at least one compensation blade 13, wherein the nominal cutting circle 17.1 and the compensation cutting circle 17.2 are different. The at least one second blade 3.2 is offset forward in the axial direction 7 of the milling tool 1 by a forward offset 19 with respect to the nominal position 9 in the direction of a machining front end 21. A surface machining cutting circle 17.3 is assigned to the at least one second blade 3.2. The surface machining cutting circle 17.3 is smaller than the nominal cutting circle 17.1 and than the compensation cutting circle 17.2. Furthermore, the at least one second blade 3.2 leads the plurality of first blades 3.1 in the circumferential direction 5.

In particular, the nominal cutting circle 17.1 is assigned to at least one first blade 3.1 of the plurality of first blades 3.1 that is not assigned to the compensation group 11.

In particular, at least one first blade 3.1 arranged on the nominal cutting circle 17.1 in particular immediately leads the at least one second blade 3.2.

Furthermore, the at least one non-compensation blade 15 in particular immediately follows the at least one compensation blade 13.

FIG. 1 a) shows a view in the direction of a z-axis from below onto the machining front end 21 of the first embodiment of the milling tool 1. The different cutting circles 17 of the blades 3 can be clearly seen.

In particular, the compensation blade 13 is offset radially inwards by a first back offset r₁ relative to the nominal cutting circle 17.1 and arranged on the compensation cutting circle 17.2. Furthermore, the second blade 3.2 is offset radially inwards by a surface machining back offset 23 relative to the nominal cutting circle 17.1 and arranged on the surface machining cutting circle 17.3.

In particular, the first blades 3.1 each include a splitting angle α in pairs, wherein the splitting angles αᵢ, in particular the first splitting angle α₁ and the second splitting angle α₂, comprise a relative size difference of at most 15% among one another.

FIG. 1 b) shows a side view of the first example of the milling tool 1. The nominal position 9 and the forward offset 19 of the at least one second blade 3.2 can be clearly seen here.

In particular, the plurality of first blades 3.1 is configured for pre-machining the workpiece 25. Alternatively or additionally, the at least one second blade 3.2 is preferably configured for finish machining the workpiece 25. In particular, the milling tool is moved along a machining direction 26.

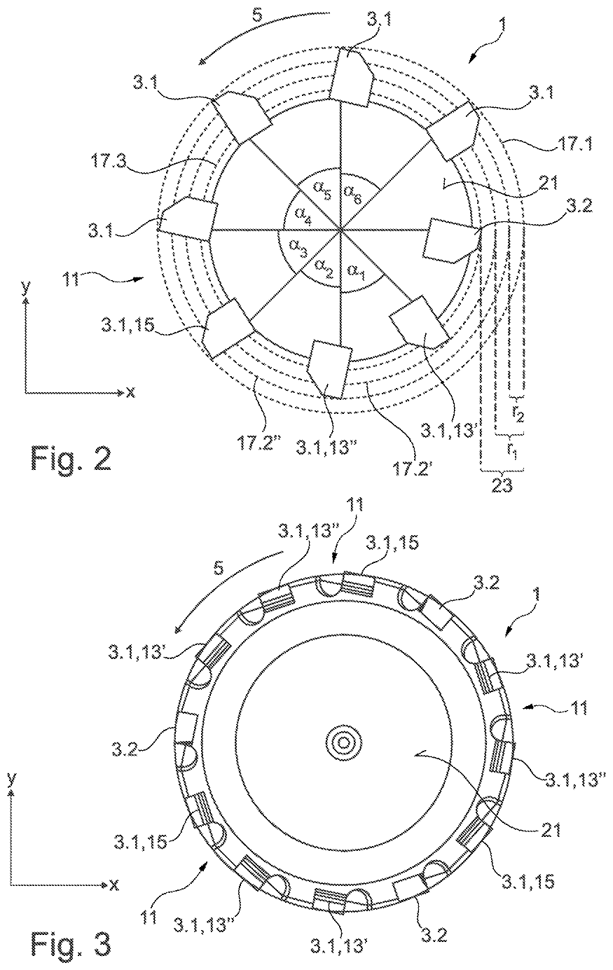

FIG. 2 shows a schematic representation of a second embodiment of the milling tool 1.

Identical and functionally identical elements are provided with the same reference signs in all figures, so that reference is made to the previous description in this respect.

The second embodiment according to FIG. 2 comprises, analogously to the first embodiment according to FIG. 1, exactly one second blade 3.2, in particular configured as a wide finishing cutting edge. Furthermore, the milling tool 1 comprises, in particular, seven first blades 3.1.

In particular, the compensation group 11 comprises two compensation blades 13, in particular a first compensation blade 13′ and a second compensation blade 13″. The at least two compensation blades 13 are assigned various compensation cutting circles 17.2; in particular, the first compensation blade 13′ is assigned a first compensation cutting circle 17.2′ and the second compensation blade 13″ is assigned a second compensation cutting circle 17.2″. In addition, the at least two compensation blades 13 are arranged directly adjacent to one another.

Preferably, the first compensation blade 13′ is offset radially inwards by a first back offset r₁ relative to the nominal cutting circle 17.1 and arranged on the first compensation cutting circle 17.2′. Furthermore, the second compensation blade 13″ is preferably offset radially inwards by a second back offset r₂ relative to the nominal cutting circle 17.1 and arranged on the second compensation cutting circle 17.2″, wherein the first back offset r₁ is preferably greater than the second back offset r₂.

FIG. 3 shows a schematic representation of a third embodiment of the milling tool 1.

In particular, the third embodiment of the milling tool 1 comprises three second blades 3.2 configured in particular as wide finishing cutting edges. In addition, the milling tool 1 comprises three compensation groups 11, each having at least one compensation blade 13 and at least one non-compensation blade 15.

In terms of the arrangement of the blades 3 in the axial direction 7 and a radial direction in an x-y plane, all three compensation groups 11 are preferably configured identically. Furthermore, every second blade 3.2 of the three second blades 3.2 is arranged on the milling tool 1 analogously to the first embodiment according to FIG. 1 or the second embodiment according to FIG. 2. In addition, each compensation group 11 of the three compensation groups 11 is configured and arranged on the milling tool 1 in a manner analogous to the first embodiment according to FIG. 1 or the second embodiment according to FIG. 2.

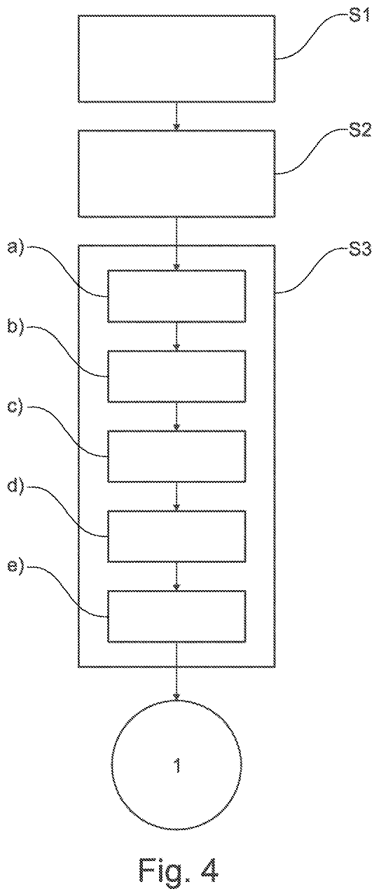

FIG. 4 shows a flow chart of an embodiment of a method for designing the milling tool 1.

In a first step S1, an angular position is determined for each of the plurality of first blades 3.1 and for the at least one second blade 3.2 in the circumferential direction 5 on the milling tool 1.

In a second step S2, the nominal cutting circle 17.1 of the at least one non-compensation blade 15 is defined.

In a third step S3, the first compensation blade 13′ of the at least one compensation blade 13 is radially set back relative to the nominal cutting circle 17.1 by the first back offset r₁.

Preferably, the first back offset r₁ for the first compensation blade 13′ of the at least one compensation blade 13 is selected depending on at least one parameter, which is selected from a predetermined additional load q of the compensation blades 13 and a tooth feed per revolution f_{z} for the milling tool 1.

In the third step S3, the second compensation blade 13″ of the at least two compensation blades 13 is preferably additionally radially set back relative to the nominal cutting circle 17.1 by the second back offset r₂, wherein the first back offset r₁ is greater than the second back offset r₂. In addition, the second back offset r₂ for the second compensation blade 13″ is preferably selected as a function of at least one parameter, which is selected from the predetermined additional load q of the compensation blades 13 and the tooth feed per revolution f_{z} for the milling tool 1.

In particular, in a first third step a) the tooth feed per revolution f_{z} for the milling tool 1 and the predetermined additional load q of the compensation blades 13 are determined. Subsequently, in a second third step b), a machining compensation K_{zer} based on the tooth feed f_{z} and the predetermined additional load q is determined, in particular using equation (1). After that, in a third step c), based on the machining compensation K_{zer}, a number nₖ of compensation blades 13 is determined, in particular using equation (2). Furthermore, in a fourth third step d), a back offset rᵢ is determined for each blade 3 of the number nₖ of compensation blades 13, in particular using equation (4). After that, in a fifth third step e), the compensation blades 13 are each offset radially inwards by the assigned back offset rᵢ with respect to the nominal cutting circle 17.1.

The foregoing description of the embodiment has been provided for purposes of illustration and description. It is not intended to be exhaustive or to limit the disclosure. Individual elements or features of a particular embodiment are generally not limited to that particular embodiment, but, where applicable, are inter-changeable and can be used in a selected embodiment, even if not specifically shown or described. The same may also be varied in many ways. Such variations are to be regarded as a departure from the disclosure, and all such modifications are intended to be included within the scope of the disclosure.

1. A milling tool having a plurality of first blades and at least one second blade, which are arranged on the milling tool in a staggered manner in the circumferential direction of the milling tool, wherein
the plurality of first blades are arranged in the axial direction of the milling tool at a nominal position, wherein
the plurality of first blades comprises a compensation group having at least one compensation blade and at least one non-compensation blade, wherein
the at least one non-compensation blade is assigned a nominal cutting circle, wherein
the at least one compensation blade is assigned a compensation cutting circle, wherein
the nominal cutting circle and the compensation cutting circle are different, wherein
the at least one second blade is offset forward in the axial direction of the milling tool by a forward offset with respect to the nominal position in the direction of a machining front end, wherein
the at least one second blade is assigned a surface machining cutting circle, wherein
the surface machining cutting circle is smaller than the nominal cutting circle and than the compensation cutting circle, wherein
the at least one second blade leads the plurality of first blades in the circumferential direction.

2. The milling tool according to claim 1, wherein the compensation group comprises at least two compensation blades, wherein different compensation cutting circles are associated with the at least two compensation blades, wherein the at least two compensation blades are directly adjacent to one another.

3. The milling tool according to claim 1, wherein the at least one non-compensation blade immediately follows the at least one compensation blade.

4. The milling tool according to claim 1, wherein the plurality of first blades is configured for pre-machining the workpiece, and wherein preferably the at least one second blade is configured for finish machining the workpiece.

5. The milling tool according to claim 1, wherein a first compensation blade of the at least one compensation blade is offset radially inwards by a first back offset relative to the nominal cutting circle and is arranged on a first compensation cutting circle.

6. The milling tool according to claim 5, wherein a second compensation blade of the at least two compensation blades is offset radially inwards by a second back offset relative to the nominal cutting circle and is arranged on a second compensation cutting circle, wherein the first back offset of the first compensation cutting circle relative to the nominal cutting circle is greater than the second back offset of the second compensation cutting circle relative to the nominal cutting circle.

7. The milling tool according to claim 1, wherein the first blades each include a splitting angle in pairs, wherein the splitting angles comprise a relative size difference of at most 15% among themselves.

8. A method for designing a milling tool according to claim 1, wherein
an angular position for each of the plurality of first blades and the at least one second blade is defined on the milling tool in the circumferential direction, wherein
the nominal cutting circle of the at least one non-compensation blade is defined, wherein
a first compensation blade of the at least one compensation blade is radially set back relative to the nominal cutting circle by a first back offset, and wherein
preferably, the first back offset for the first compensation blade of the at least one compensation blade is selected as a function of at least one parameter, which is selected from a predetermined additional load of the compensation blades and a tooth feed per revolution for the milling tool.

9. The method for designing a milling tool according to claim 8, wherein
a second compensation blade of the at least two compensation blades is radially set back relative to the nominal cutting circle by a second back offset, wherein
wherein the first back offset is greater than the second back offset, and wherein
wherein the second back offset for the second compensation blade is preferably selected as a function of at least one parameter selected from the predetermined additional load of the compensation blades and the tooth feed per revolution for the milling tool.

10. The method according to claim 8, wherein
a) the tooth feed per revolution for the milling tool and the predetermined additional load of the compensation blades are determined, wherein
b) machining compensation is determined based on the tooth feed and the predetermined additional load, wherein
c) a number of compensation blades is determined based on the machining compensation, wherein
d) a respective back offset is determined for each blade of the number of compensation blades, wherein
e) the compensation blades are each offset radially inwards by the associated back offset with respect to the nominal cutting circle.
